(19) United States
(12) Patent Application Publication
(10) Pub. No.: US 2006/0206891 A1
(43) Pub. Date: Sep. 14, 2006

(54) System and method of maintaining strict hardware affinity in a virtualized logical partitioned (LPAR) multiprocessor system while allowing one processor to donate excess processor cycles to other partitions when warranted

(75) Inventors: William Joseph Armstrong, Rochester, MN (US); Timothy Richard Marchini, Hyde Park, NY (US); Naresh Nayar, Rochester, MN (US); Bret Ronald Olszewski, Austin, TX (US); Mysore Sathyanarayana Srinivas, Austin, TX (US)

Correspondence Address: IBM CORPORATION (VE);C/O VOLEL EMILE, P. O. BOX 202170, AUSTIN, TX, 78720-2170, US

(73) Assignee: International Business Machines Corporation

(21) Appl. No.: 11/077,324

(22) Filed: Mar. 10, 2005

(51) Int. Cl. G06F 9/455

(52) U.S. Cl. 718/1

(57) ABSTRACT

A system, computer program product and method of logically partitioning a multiprocessor system are provided. The system is first partitioned into a plurality of partitions and each partition is assigned a percentage of the resources of the system. However, to provide the system with virtual machine capability, virtual resources, rather than physical resources, are assigned to the partitions. The virtual resources are mapped and bound to the physical resources that are available in the system. Because of the virtual machine capability of the system, logical partitions that are in need of resources that are assigned to other partitions are allowed to use those resources if the resources are idle.

### BACKGROUND OF THE INVENTION

1. Technical Field

The present invention is directed to multiprocessor computer systems. More specifically, the present invention is directed to a virtualized logical partitioned (LPAR) multiprocessor system that maintains strict hardware affinity and allows partitions to donate excess processor cycles to other partitions when warranted.

2. Description of Related Art

In recent years, there has been a trend toward increasing processing power of computer systems. One method that has been used to achieve this end is to use multi-processor (MP) computer systems. Note that MP computer systems include symmetric multiprocessor (SMP) systems, non-uniform memory access (NUMA) systems etc. The actual architecture used in an MP computer system depends on different criteria including requirements of particular applications, performance requirements, software environment of each application etc.

For increased performance, the system may be partitioned to make subsets of the resources on the system available to specific applications. This approach avoids dedicating the system's resources permanently to any partition since the partitions can be changed. Note that when a computer system is logically partitioned, multiple copies (i.e., images) of a single operating system (OS) or a plurality of different OSs are usually simultaneously executing on the computer system hardware platform.

In some environments, a virtual machine (VM) may be used. A VM, which is a product of International Business Machines Corporation of Armonk, N.Y., uses a single physical machine, with one or more physical processors, in combination with software which simulates multiple virtual machines. Each one of these virtual machines may have access to a subset of the physical resources of the underlying real computer. The assignment of resources to each virtual machine is controlled by a program called a hypervisor. Thus, the hypervisor, not the OSs, deals with the allocation of physical hardware. The VM architecture supports the concept of logical partitions (LPARs).

The hypervisor interacts with the OSs in a limited number of carefully architected manners. As a result, the hypervisor typically has very little knowledge of the activities within the OSs. This lack of knowledge, in certain instances, can lead to performance inefficiencies. For example, OSs such as IBM's i5/OS, IBM's AIX (Advanced Interactive executive) OS, IBM's PTX OS, Microsoft's Windows XP etc. have been adapted to optimize certain features in NUMA class hardware. Some of these optimizations include preferential allocation of local memory and scheduling, cache affinity for sharing data, gang scheduling, physical input/output (I/O) processing.

In a preferential allocation of local memory and scheduling optimization, when a dispatchable entity (e.g., a process, a thread) needs a page of memory, the OS will attempt to use a page which is located from the most tightly coupled memory as possible. Specifically, the OS will attempt to schedule entities that request memory affinity on processors most closely associated with their allocated memory. If an entity that requests memory affinity is not particularly sensitive to scheduling time, the entity may be placed in the queue of a processor that is closely associated with its memory if an idle one is not readily available. For entities that are not particularly sensitive to memory affinity, they can be executed by any processor.

The hypervisor generally attempts to map virtual processors onto physical processors with affinity properties. However, the hypervisor does not do so because an entity requires that it be executed by such a processor. Consequently, the hypervisor may sometimes map a virtual processor that is to process an entity that requires affinity to a physical processor that does not have affinity properties. In such cases, the preferential allocation of local memory and scheduling optimization will be obviated.

Cache affinity for sharing of data entails dispatching two entities that are sharing data through an inter-process communication, such as a UNIX pipe for example, to two processors that share a cache. This way, the passing of data between the two entities may be more efficient.

Again the hypervisor, which does not have a clear view of the OSs' actions, may easily defeat this optimization by mapping virtual processors which have been designated by an OS to physical processors that do not share a cache.

There are entities that are specifically architected around message passing. These entities are extremely sensitive to when they are dispatched for execution. That is, these entities run best when they are scheduled together (gang scheduling) and on dedicated processors. This way, the latency that is usually associated with message passing may be greatly reduced.

Since the hypervisor is usually unable to determine if gang scheduling is required, it may schedule or dispatch one or more of these entities at different times and to physical processors that are not dedicated to those entities. This then may dramatically affect processing performance of the entities as a first entity may have to wait for a second entity to be processed to receive data from or transfer data to the first entity.

Physical I/O processing in UNIX systems, for example, is strongly tied to interrupt delivery. For instance, suppose there is a high speed adapter, connected to the system, which sometimes handles both short and large messages. Although the processor that receives an I/O interrupt generally handles the interrupt, the system may nonetheless be optimized toward latency or whichever physical processor may handle the interrupt immediately for short messages and tie the interrupts to physical processors on the same building block as the I/O devices handling the data for large messages. This scheme enhances performance because small messages generally do not overly tax memory interconnect between building blocks of a NUMA system; and thus, it does not matter which processor handles those messages. Large messages, on the other hand, do tax the interconnect quite severely. Consequently, if the large messages are steered toward processors that are on the same building blocks as the adapters that are handling those messages, the use of the interconnect may be obviated.

Once again, the hypervisor may not ensure that large messages are steered toward processors that are on the same building blocks as the adapters that are handling the messages. Hence, there may be times when large messages are processed by processors that are not on the same building blocks as the adapters handling them thereby overloading the interconnect.

Due to the above-disclosed problems, therefore, a need exists for a virtualized logical partitioned (LPAR) system that maintains strict hardware affinity. This LPAR system may nonetheless allow one partition to donate excess processor cycles to other partitions when warranted.

### SUMMARY OF THE INVENTION

The present invention provides a system, computer program product and method of logically partitioning a multiprocessor system. The system is first partitioned into a plurality of partitions and each partition is assigned a percentage of the resources of the system. However, to provide the system with virtual machine capability, virtual resources, rather than physical resources, are assigned to the partitions. The virtual resources are mapped and bound to the physical resources that are available in the system. Because of the virtual machine capability of the system, logical partitions that are in need of resources that are assigned to other partitions are allowed to use those resources if the resources are idle.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a block diagram of a non-uniform memory access (NUMA) system.

FIG. 2 illustrates exemplary logical partitions of the system.

FIG. 3 is a flowchart of a first process that may be used by the present invention.

FIG. 4 is an examplary table of available resources that may be used by the present invention.

FIG. 5 is a flowchart of a second process that may be used by the present invention.

### DETAILED DESCRIPTION OF THE PREFERRED EMBODIMENT

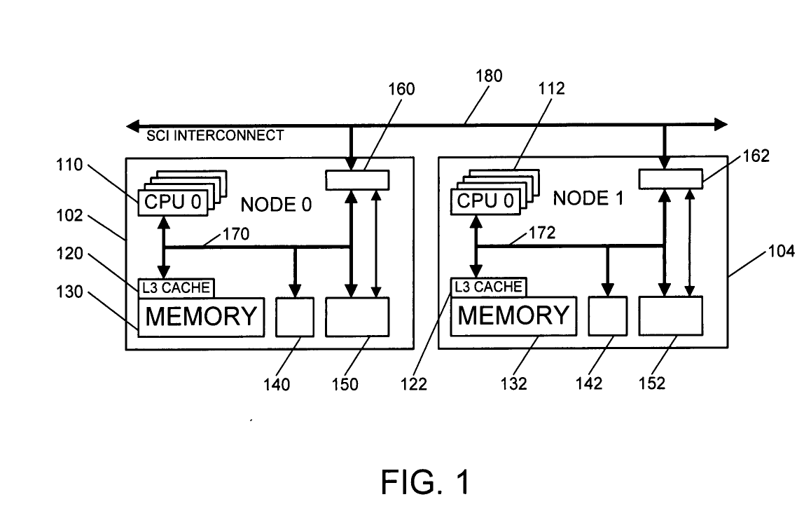

With reference now to the figures, FIG. 1 depicts a block diagram of a non-uniform memory access (NUMA) system. Note that although the invention will be explained using a NUMA system. It is not thus restricted. Any multi-processor system may be used. Thus, the use of the NUMA system is for illustrative purposes only.

The NUMA system has two nodes, node 0 102 and node 1 104. Each node is a 4-processor SMP system (see CPUs 110 and CPUs 112) with a shared cache (L3 caches 120 and 122). Each CPU may contain an L1 cache and an L2 cache (not shown). Each node also has a local memory (i.e., memories 130 and 132), I/O interface (I/O interfaces 140 and 142) for receiving and transmitting data, a remote cache (remote caches 150 and 152) for caching data from remote nodes, and a lynxer (lynxers 160 and 162).

The data processing elements in each node are interconnected by a bus (buses 170 and 172) and the two nodes (node 0 102 and node 1 104) are connected to each other via a scalable coherent interface (SCI) bus 180 and the lynxers 160 and 162. Lynxers 160 and 162 contain the SCI code. SCI is an ANSI/ISO/IEEE Standard 1596-1992 that enables smooth system growth with modular components from vendors at 1 GByte/second/processor system flux, distributed shared memory with optional cache coherence, message passing mechanisms and scalable from 1 through 64K processors. A key feature of SCI is that it provides for tightly coupled systems with a common global memory map.

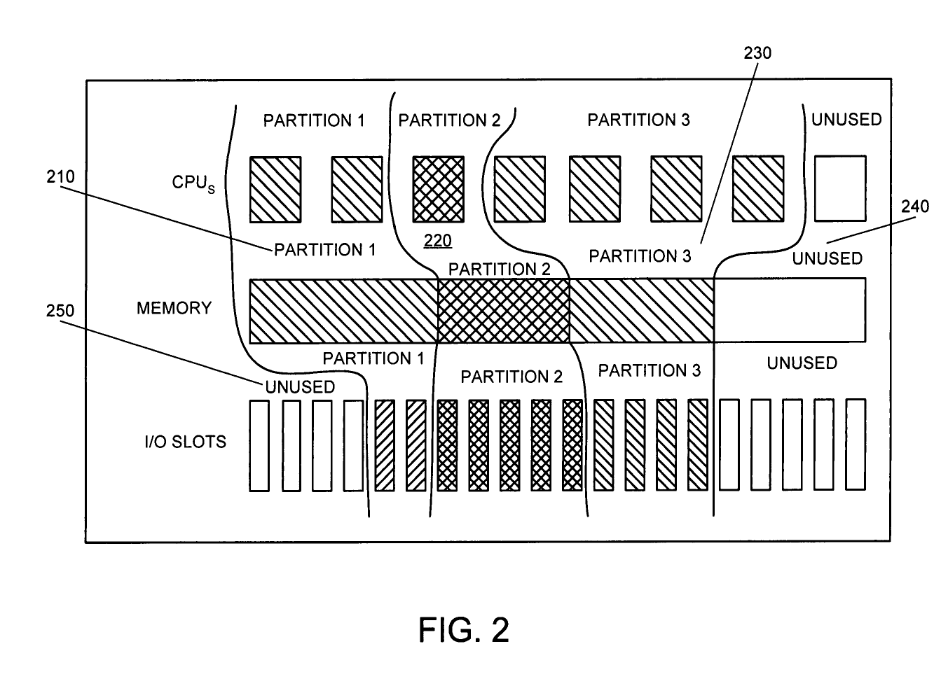

As mentioned earlier, the NUMA system of FIG. 1 may be partitioned. FIG. 2 illustrates exemplary logical partitions of the system. In FIG. 2, three partitions are shown and one unused area of the system. Partition 1 210 has two (2) processors, two (2) I/O slots and a percentage of the memory device. Partition 2 220 uses one (1) processor, five (5) I/O slots and also used a smaller percentage of the memory device. Partition 3 230 uses four (4) processors, five (5) I/O slots and uses a larger percentage of the memory device. Areas 240 and 250 of the computer system are not assigned to a partition and are unused. Note that in FIG. 2 only subsets of resources needed to support an operating system are shown.

When a computer system without VM capability is partitioned, all its hardware resources that are to be used are assigned to a partition. The hardware resources that are not assigned are not used. More specifically, a resource (e.g., CDROM drive, diskette drive, parallel, serial port etc.) may either belong to a single partition or not belong to any partition at all. If the resource belongs to a partition, it is known to and is only accessible to that partition. If the resource does not belong to any partition, it is neither known to nor is accessible to any partition. If a partition needs to use a resource that is assigned to another partition, the two partitions have to be reconfigured in order to move the resource from its current partition to the desired partition. This is a manual process, which involves invoking an application at a hardware management console (HMC) and may perhaps disrupt the partitions during the reconfiguration.

In an LPAR system with VM capability, FIG. 2 represents virtual partitions. That is, the OS running in a partition may designate which virtual resources (i.e., CPU, memory area etc.), as per the map in FIG. 2, to use when an entity is being processed. However, the hypervisor chooses the actual physical resources that are to be used when processing the entity. In doing so, the hypervisor may use any resource in the computer system, as per FIG. 1. As mentioned before, the hypervisor does attempt to schedule virtual processors onto physical processors with affinity properties. However, this is not guaranteed.

The present invention creates a new model of virtualization. In this model, a strict binding of virtual resources presented to an OS in a partition is created with the physical resources assigned to that partition. However, idle resources from one partition may be used, upon consent from the OS executing in the partition, by another partition. In other words, the LPAR system may run as if it does not have any VM capability (i.e., FIG. 2 becomes a physical map rather than a virtual map of the LPAR system). However, resources from one partition may be used by another partition upon consent. Thus, all affinity features (i.e., memory affinity, cache affinity, gang scheduling, I/O interrupt optimization, etc.) are preserved while the system is running under the supervision of the hypervisor.

The strict binding may be at the processor level or the building block level. In any case, when a virtual processor within a partition becomes idle, the physical processor that is bound to the (idle virtual) processor may be dispatched to guest partitions as needed. The length of time that a guest partition may use a borrowed resource (such as a processor for example) may be limited to reduce any adverse performance that the lender partition may suffer as a result. Note that CPU time accounting may be virtualized to include time gifted to guest partitions or not.

Additionally, a strict notion of priority may be implied. For example, any event which would cause a partition's virtual processor to become non-idle may revert the use of the processor to the lender partition. Events which may awaken a previously idle virtual processor may include I/O interrupts, timers, OS initiated hypervisor directives from other active virtual processors.

In general, physical I/O interrupts associated with devices owned by a lender partition will be delivered directly to physical processors assigned to the lender partition. OSs operating on guest partitions will only receive logical interrupts as delivered by the hypervisor.

Thus, the present invention allows an LPAR system to maintain all the performance advantages that are associated with non-LPAR systems but allows a more efficient use of resources in an LPAR system by allowing one partition to use idle cycles from another partition.

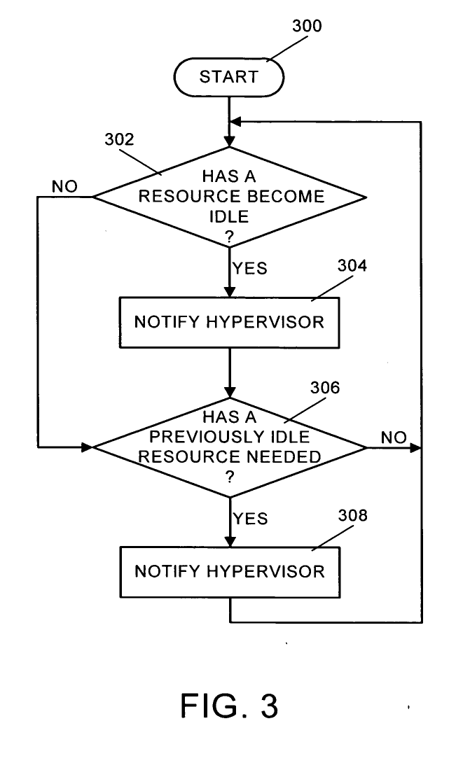

FIG. 3 is a flow chart of a first process that may be used by the present invention. The process executes on all partitions of an LPAR system and starts when the system is turned on or is reset (step 300). Once executing, a check is made to determine if any of the resources assigned to a partition (i.e., the partition in which the process is running) becomes idle (step 302). If so, the hypervisor is notified. The hypervisor may then update a table of available resources (step 304).

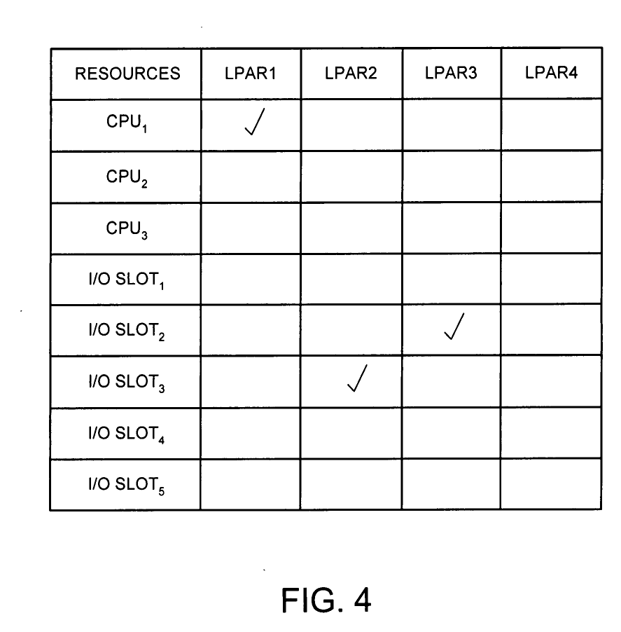

An exemplary table of available resources that may be used by the hypervisor is the table in FIG. 4. In that table, it is shown that CPU₁ which is assigned to LPAR₁ is idle. Likewise, I/O slot₃ assigned to LPAR₂ and I/O slot₂ assigned to LPAR₃ are idle. Hence, the hypervisor may allow any partition that is in need of a CPU to use the available CPU₁ from LPAR₁. Further, any partition that is in need of I/O slot may be allowed to use either the available I/O slot₃ from LPAR₂ or I/O slot₂ from LPAR₃.

Returning to FIG. 3, if none of the resources of the partition becomes idle (step 302) or after the hypervisor has been notified of an idle resource or resources (step 304), the process will jump to step 306. In step 306, a check is done to determine if a previously idle resource is needed by the partition to which it is assigned (step 306). As mentioned above, this could happen due to a variety of reasons including I/O interrupts, timers, OS initiated hypervisor directives etc. If this occurs, the hypervisor will be notified (step 308) and the process will jump back to step 302. If no previously idle resource is needed, then the process will jump back to step 302. The process ends when the computer system is turned off or the LPAR in which it is executing is resetting.

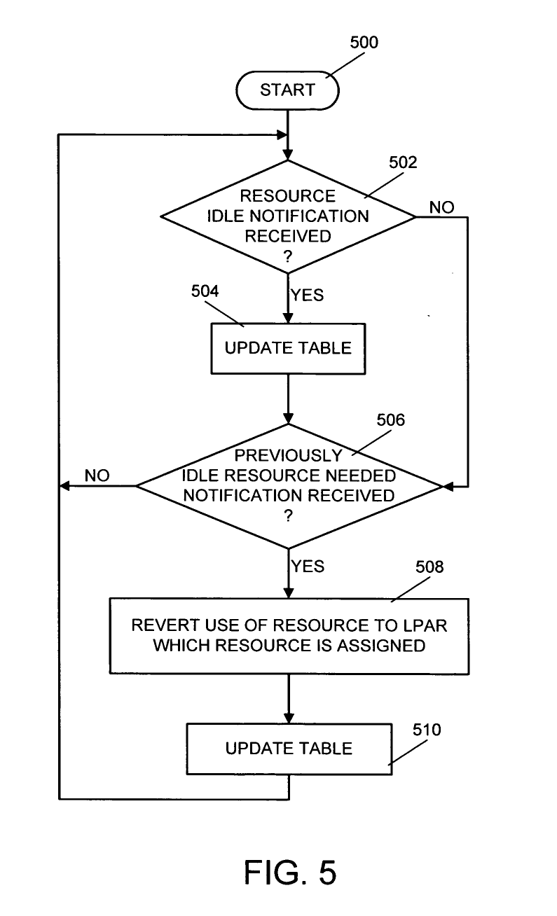

FIG. 5 is a flowchart of a second process that may be used by the invention. The process starts when the system is turned on is reset (step 500). Then a check is made to determine whether a “resource idle notification” has been received by any one of the partitions in the system (step 502). If so, the available table (see FIG. 4) is updated (step 504). After updating the table or if a resource idle notification has not been received, the process will proceed to step 506. In step 506, a check is made to determine whether a previously idle resource is needed by the partition to which the resource is originally assigned. If so, the use of the resource is reverted to the partition (step 508).

Depending on the policy in use, the use of the resource may be reverted to its original partition as soon as the “previously idle resource needed notification” is received in order to reduce any adverse performance impact to the lender partition. Alternatively, the use of the resource may be reverted once the guest partition is done with the task that it was performing when the notification was received.

After the use of the resource has reverted to the partition to which it is assigned, the table is again updated (step 510) before the process jumps back to step 502. If a “previously idle resource needed notification” has not been received, then the process jump back to step 502. The process will end when the computer system is turned off or is reset.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of logically partitioning a multiprocessor system having virtual machine capability comprising the step of:
logically partitioning the system into a plurality of partitions;
assigning virtual resources to each partition;
mapping virtual resources assigned to each logical partition to physical resources available in the system;
binding the virtual resources to the physical resources; and
allowing a first logical partition to use resources assigned to a second partition if the resources are idle.

2. The method of claim 1 wherein the step of mapping virtual resources to physical resources is performed by using a logical partitioned resource map.

3. The method of claim 1 wherein when the second partition is in need of the resources being used by the first partition, the use of the resources is reverted to the second partition.

4. The method of claim 3 wherein the use of the resources is reverted immediately to the second partition.

5. The method of claim 3 wherein the use of the resources is reverted once the first partition has finished using the resources.

6. The method of claim 1 wherein the resources are processors.

7. The method of claim 1 wherein the resources are input, output (I/O) slots.

8. A computer program product on a computer readable medium for logically partitioning a multiprocessor system having virtual machine capability comprising:
code means for logically partitioning the system into a plurality of partitions;
code means for assigning virtual resources to each partition;
code means for mapping virtual resources assigned to each logical partition to physical resources available in the system;
code means for binding the virtual resources to the physical resources; and
code means for allowing a first logical partition to use resources assigned to a second partition if the resources are idle.

9. The computer program product of claim 8 wherein the code means for mapping virtual resources to physical resources is performed by using a logical partitioned resource map.

10. The computer program product of claim 8 wherein when the second partition is in need of the resources being used by the first partition, the use of the resources is reverted to the second partition.

11. The computer program product of claim 10 wherein the use of the resources is reverted immediately to the second partition.

12. The computer program product of claim 10 wherein the use of the resources is reverted once the first partition has finished using the resources.

13. The computer program product of claim 8 wherein the resources are processors.

14. The computer program product of claim 8 wherein the resources are input, output (I/O) slots.

15. A logically partitioned multiprocessor system having virtual machine (VM) capability comprising:
at least one storage device for storing code data; and
at least one processor for processing the code data to logically partition the system into a plurality of partitions, to assign virtual resources to each partition, to map virtual resources assigned to each logical partition to physical resources available in the system, to bind the virtual resources to the physical resources, and to allow a first logical partition to use resources assigned to a second partition if the resources are idle.

16. The logically partitioned multiprocessor system of claim 15 wherein the code data is further processed to of map virtual resources to physical resources by using a logical partitioned resource map.

17. The logically partitioned multiprocessor system of claim 15 wherein when the second partition is in need of the resources being used by the first partition, the use of the resources is reverted to the second partition.

18. The logically partitioned multiprocessor system of claim 17 wherein the use of the resources is reverted immediately to the second partition.

19. The logically partitioned multiprocessor system of claim 17 wherein the use of the resources is reverted once the first partition has finished using the resources.

20. The logically partitioned multiprocessor system of claim 15 wherein the resources are processors.
